(19) United States
(12) Patent Application Publication
(10) Pub. No.: US 2017/0318590 A1
(43) Pub. Date: Nov. 2, 2017

(54) SIGNAL TRANSMISSION METHOD AND DEVICE

(71) Applicant: LG ELECTRONICS INC., Seoul (KR)

(72) Inventors: Ilmu BYUN, Seoul (KR); Heejeong CHO, Seoul (KR); Hyunsoo KO, Seoul (KR); Hyeyoung CHOI, Seoul (KR); Kungmin PARK, Seoul (KR)

(21) Appl. No.: 15/523,836

(22) PCT Filed: Nov. 4, 2014
(86) PCT No.: PCT/KR2014/010523

§ 371 Date: May 2, 2017

(51) Int. Cl. H04W 72/04; H04W 16/28

(52) U.S. Cl. CPC H04W 72/0473; H04W 16/28

(57) ABSTRACT

The signal transmission method according to the present invention comprises: determining the beam width of a beam to be transmitted; based on the beam width, determining relative narrowband transmit power (RNTP) information indicating whether or not to transmit, to a preset resource block, transmission power equal to or greater than a preset critical value; transmitting the RNTP information to an adjacent cell; and transmitting the generated beam to the resource block according to the RNTP information. Accordingly, provided is a method for setting a relative narrowband transmit power (RNTP) value so as to control interference between cells in a communication system.

### BACKGROUND OF THE INVENTION

### Field of the Invention

The present invention relates to a method and apparatus for transmitting a signal, and more particularly, to a method and apparatus for configuring an RNTP for controlling inter-cell interference through a beam width adjustment.

### Related Art

Recently, commercialization of the long term evolution (LTE) system, which is the next generation of wireless communication systems, has been supported earnestly. After the necessities were recognized that mass data service is to be supported in high-quality in response to users' request as well as voice service while ensuring users' mobility, the trend is that such an LTE system has been more rapidly expanded. The LTE system provides low transmission delay, high transmission rate, high system capacity and coverage improvement.

Owing to the advent of such a high-quality service, needs for wireless communication service have been abruptly increased. In order to actively cope with such a situation, more than anything else, the capacity of the communication system should be increased. The way for increasing the communication capacity in the wireless communication environment may include a method for newly finding available frequency band and a method for increasing efficiency for the limited resource.

As a method for increasing efficiency of the limited resource, a technique for increasing a transmission capacity, so-called the multiple antenna transmission and reception technique has been vigorously developed with a great attention, which takes a diversity gain by additionally securing the spatial area for the resource utilization by mounting multiple antennas on a transceiver or increases a transmission capacity by transmitting data in parallel through each antenna.

In the multiple antenna system, the beamforming and the precoding may be used for increasing the Signal to Noise Ratio (SNR). In the closed-loop system that may use feedback information in a transmission end, the beamforming and the precoding are used for maximizing the SNR through the corresponding feedback information.

### SUMMARY OF THE INVENTION

An embodiment of the present invention is to propose a method for configuring a relative narrowband transmit power (RNTP) value in order to perform the inter-cell interference control in the communication system to which the flexible beamforming is applied.

An embodiment of the present invention is to propose a method of configuring an RNTP value by considering the case that antennas are arrayed in 2D.

An embodiment of the present invention is to propose a method of configuring an RNTP value by considering a directing point of a beam in the case that antennas of the beam are arrayed in 2D.

Further embodiment of the present invention is to propose a method of configuring an RNTP value by considering an array factor or a beam width.

Another embodiment of the present invention is to propose a method of configuring an RNTP value by considering an antenna gain.

Still another embodiment of the present invention is to propose a method of configuring an RNTP value by considering an antenna gain and a transmission power together.

A method for transmitting a signal according to the present invention may include determining a directional point of a beam that is going to be transmitted, determining relative narrowband transmit power (RNTP) information that represents whether a transmission power greater than a preconfigured threshold value is transmitted to a preconfigured resource block based on the directional point of a beam, and transmitting the RNTP information to a neighboring cell, and transmitting a generated beam to the resource block according to the RNTP information.

The method may further include calculating an array factor that includes the directional point of a beam and information of a change of a maximum antenna gain in a cell-edge direction according to the directional point of a beam, and the step of determining the RNTP information may be determined by comparing the array factor with a preconfigured array factor.

The method may further include calculating an array gain for the beam, and the step of determining the RNTP information may be determined by comparing the array gain with a preconfigured array gain.

The step of calculating the array gain for the beam may perform a multiplication of a single antenna gain for transmitting a beam by an array factor that includes information of the beam width and a change of a maximum antenna gain in a cell-edge direction according to the directional point of a beam.

The method may further include calculating an array gain for the beam and a gain energy induced by a multiplication of the array gain for the beam by a maximum energy for a resource block, and the step of determining the RNTP information may be determined by comparing the gain energy with preconfigured gain energy.

A weighting may be attributed to the array gain in calculating the gain energy.

### Advantageous Effects

According to the present invention, a method is provided for configuring a relative narrowband transmit power (RNTP) value in order to perform the inter-cell interference control in the communication system to which the flexible beamforming is applied.

According to the present invention, a method is provided for configuring an RNTP value by considering a directing point of a beam in the case that antennas of the beam are arrayed in 2D.

### BRIEF DESCRIPTION OF THE DRAWINGS

FIG. 1 is a diagram for describing the inter-cell interference coordination in the LTE system.

FIG. 2 illustrates a radiation pattern of the half-wave dipole antenna.

FIG. 3 illustrates a radiation pattern of a circular aperture antenna, such as a satellite receiving antenna.

FIG. 4 illustrates a radiation pattern of a linear array antenna.

FIG. 5 illustrates a process of obtaining a radiation pattern of a linear array antenna.

FIG. 6 is a diagram illustrating an array of antennas arranged in two-dimension.

FIG. 7 is a diagram illustrating a change of beam gain depending on a directional point of a beam in the case of performing the vertical beamforming.

FIG. 8 is a diagram illustrating a case that the coverage of a cell is changed owing to the change of interval between base stations.

FIG. 9 is a diagram illustrating parameters for a vertical direction of a beam when two-dimensional beamforming is performed.

FIG. 10 is a diagram illustrating parameters for a horizontal direction of a beam when two-dimensional beamforming is performed.

FIG. 11 is a diagram for describing a signal transmission method according to an embodiment of the present invention.

FIG. 12 is a block diagram illustrating a wireless communication system according to the present invention.

### DESCRIPTION OF EXEMPLARY EMBODIMENTS

The present invention can be modified in various forms, and specific embodiments thereof will be described and shown in the drawings. However, the embodiments are not intended for limiting the invention. The terms used in the following description are used to merely describe specific embodiments, but are not intended to limit the invention.

Hereinafter, the preferred embodiment of the present invention now will be described in detail with reference to the accompanying exemplary drawings in this specification. In attaching reference numerals to elements in each drawing, it should be understood that the same reference numeral is used for the same element even if the element is shown in different drawings. In addition, in case that the detailed description for the related known elements and functions is determined to obscure the inventive concept in this specification, the redundant description for the same element will be omitted.

In addition, the present specification describes wireless communication network as an object, the tasks performed in the wireless communication network may be performed during the process of controlling the network in the system (for example, a base station) that controls the corresponding wireless communication network and transmitting data, or performed by the user equipment that is coupled to the corresponding wireless network.

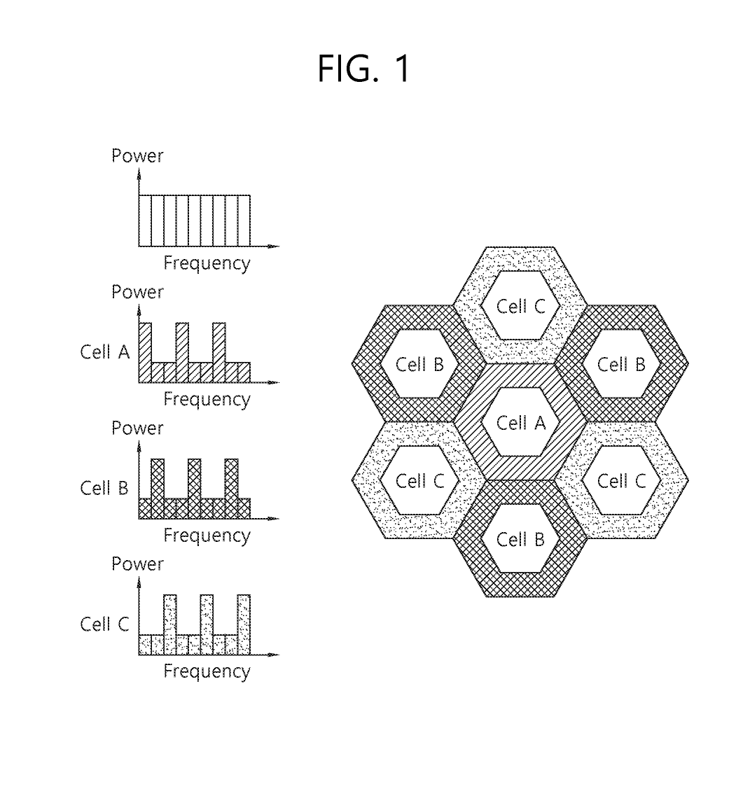

FIG. 1 is a diagram for describing the inter-cell interference coordination in the LTE system.

In the LTE system, each cell may be divided into interior and exterior. In the interior cell in which a user undergoes interference of low level and low power is required for the communication with a serving cell, the frequency reuse factor is 1.

In the case of the exterior cell, when the cell schedules a user to a part of given band, the system capacity may be optimized for the case that neighboring cells do not transmit anything or the case that neighboring cells transmit low power to the users existed inside of adjacent cells in order to avoid strong interference that may occur for the user scheduled in the first cell.

Such a limitation brings about the result of increasing the frequency reuse rate in a cell-edge, which is known as the partial frequency reuse as shown in FIG. 1.

As shown in FIG. 1, each of the cells A, B and C may be divided into interior area and exterior area, and the frequency resource for each cell-edge is allocated to a cell in order not to be overlapped in an adjacent cell. In the case that a specific frequency resource is allocated to the exterior area of cell A, the corresponding frequency resource is not allocated in cell B and cell C. And in the case that a specific frequency resource is allocated to the exterior area of cell B, the corresponding frequency resource is not allocated in cell A and cell C. In the same way, in the case that a specific frequency resource is allocated to the exterior area of cell C, the corresponding frequency resource is not allocated in cell A and cell B.

In order to coordinate the scheduling for other cells in such a way, a communication is required between neighboring cells. In the case that the neighboring cells are managed by the same base station (e.g., eNodeB), the coordinated scheduling plan may be performed without request for a standardized signaling. However, in the case that the neighboring cells are managed by different base stations, particularly, in the multivendor networks, the standardized signaling is important.

In LTE, it is assumed that the Inter-Cell Interference Coordination (ICIC) is managed in the frequency domain, rather than in the time domain, and the signaling between base stations is designed for supporting it. This is because the time domain coordination may interfere with the operation for the HARQ process like the uplink in which the synchronous Hybrid Automatic Repeat reQuest (HARQ) is used.

Regarding a downlink transmission, the bitmap expressed by a Relative Narrowband Transmit Power (RNTP) may be exchanged through an X2 interface. Each bit of an RNTP indicator that corresponds to a single resource block in the frequency domain is used for notifying whether to maintain the transmission power for the resource block below a specific upper limit to neighboring base stations. Such an upper limit and the term of validity may be preconfigured.

For example, when the RNTP indicator is 1, which represents a state that the transmission power is maintained to a specific resource block, that is, a signal transmission, and when the RNTP indicator is 0, which represents a state that a signal is not transmitted to the corresponding resource block, that is, a state that beamforming is not performed.

Accordingly, the degree of interference anticipated in each resource block may be considered when neighboring cells schedule a user in their own cells.

In the case that a base station receives the information that the transmission power of the resource block in a neighboring cell is high, the follow-up operation is not consistent. Accordingly, a certain degree of freedom is allowed for performing the scheduling algorithm. However, a typical operation may have a user in a cell-edge avoid scheduling for the resource block of which transmission power is high.

In the definition of an RNTP indicator, the transmission power per antenna port may be normalized by the maximum output power of a base station or a cell. This is because the cell that has small maximum output power owing to its small size may undergo greater interference than the cell that has great maximum output power that corresponds to the cell of which size is great.

The determination for the RNTP indicator may be performed by Equation 1.

$$RNTP ( {n}_{PRB} ) = \{ \begin{matrix}0 & if \frac{{E}_{A} ( {n}_{PRB} )}{{E}_{max\_nom}^{( p )}} \leq {RNTP}_{threshold} \\ 1 & if no promise about the upper limit of \frac{{E}_{A} ( {n}_{PRB} )}{{E}_{max\_\_nom}^{( p )}} is made\end{matrix} \qquad [ Equation 1 ]$$

In Equation 1, E_{A}(n_{PRB}) represents the maximum intended energy per resource element (EPRE) of a UE-specific physical downlink shared channel (PDSCH) REs for an orthogonal frequency division multiplexing (OFDM) symbol that does not include a reference signal (RS) in the physical resource block for antenna port p during the next specific time duration, and n_{PRB} represents the number of physical resource blocks. n_{PRB} may have a value from 0 to N_{RB}^{DL}−1. RNTP_{threshold} may have a value belonged to {−∞, −11, −10, −9, −8, −7, −6, −5, −4, −3, −2, −1, 0, +1, +2, +3} [dB] (RNTP_{threshold}ε{−∞, −11, −10, −9, −8, −7, −6, −5, −4, −3, −2, −1, 0, +1, +2, +3} [dB]).

In addition, in Equation 1, E^{(p)}ₘₐₓ_{_}ₙₒₘ may be expressed as Equation 2.

$${E}_{max\_nom}^{( p )} = \frac{{P}_{max}^{( p )} \cdot \frac{1}{Δ f}}{{N}_{RB}^{DL} \cdot {N}_{SC}^{RB}} \qquad [ Equation 2 ]$$

In Equation 2, Δf represents a subcarrier spacing, and N_{RB}^{DL} represents a Downlink bandwidth configuration. And N_{SC}^{RB} represents a resource block size in the frequency domain, expressed as the number of subcarriers.

According to Equation 1, the RNTP indicator becomes 0 when the energy

$$\frac{{E}_{A} ( {n}_{PRB} )}{( {E}_{max\_nom}^{( p )} )}$$

of a normalized RE is equal or smaller than RNTP_{threshold} which is preconfigured, and becomes 1 in the case that there is no rule in the upper limit of the energy

$$\frac{{E}_{A} ( {n}_{PRB} )}{( {E}_{max\_nom}^{( p )} )}$$

of a normalized RE. That is, the RNTP indicator may become 1 when

$$\frac{{E}_{A} ( {n}_{PRB} )}{{E}_{max\_nom}^{( p )}}$$

is greater than RNTP_{threshold}.

Meanwhile, a transmission antenna generates an electromagnetic wave which is strong in a specific direction in comparison with other directions. The representation of field strength for a direction is referred to as a radiation pattern. The radiation pattern has always the same shape in a transmission and a reception.

The electromagnetic wave measured on a point far away from the antenna corresponds to the summation of the radiation rays radiated from all parts of the antenna. Each of the small parts of the antenna radiates waves that have different widths and phases, and such radiation wave moves different distances from the point where a receiver is located. the gain of such a radiation wave may be increased in some direction and may be decreased in some other direction.

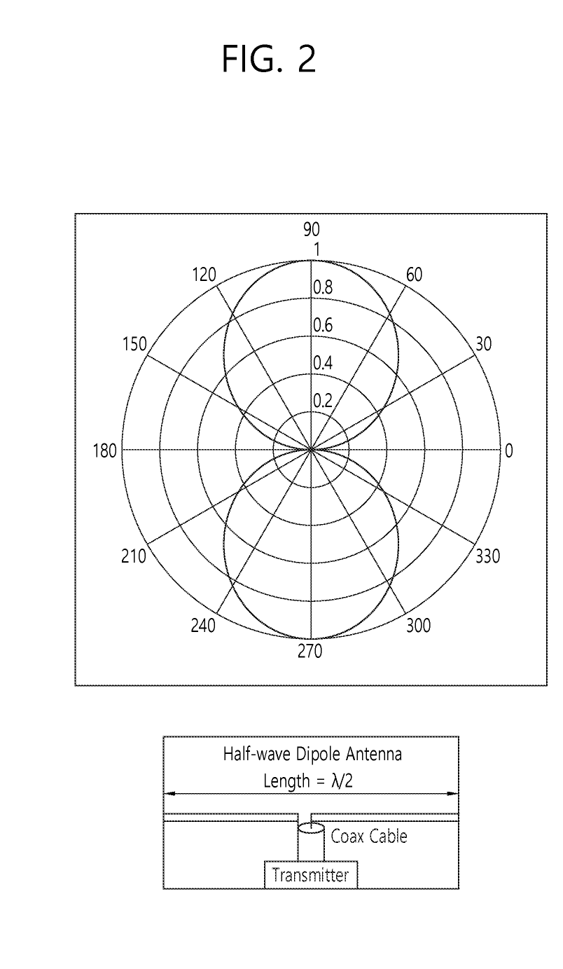

A half-wave dipole antenna is a simple half-way antenna in which a wire is connected to a disconnected central portion for cable connection. FIG. 2 illustrates a radiation pattern of the half-wave dipole antenna.

A directional antenna is designed to have gain in only one direction and to have loss in other directions. As an antenna increases in size, directivity thereof is created. A wave radiated from an antenna travels a long distance with directivity and may be more easily controlled when given a directional radiation pattern which is constructive interference or unconstructive interference.

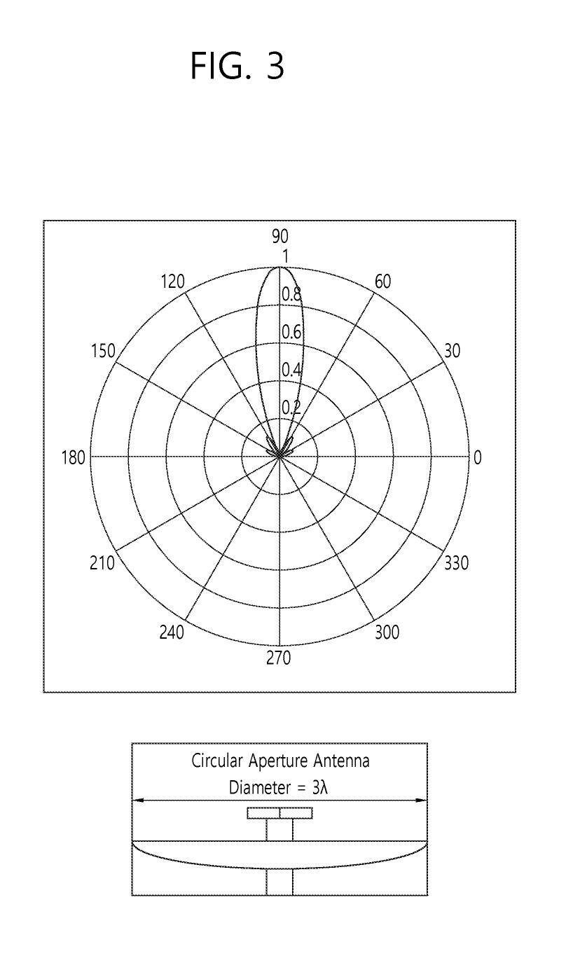

To be extremely simplified, a satellite receiving antenna is considered to be a circular surface from which the same electromagnetic waves are radiated in all parts. FIG. 3 illustrates a radiation pattern of a circular aperture antenna, such as a satellite receiving antenna.

Referring to FIG. 3, a beam with a narrow width having a high gain is disposed at the center of the radiation pattern. As the diameter of the antenna increases according to a wavelength, the width of the central beam becomes gradually narrow. Small beams called side lobes appear on both sides of the central beam. The direction of a signal with the signal strength of 0 may be expressed as “nulls.”

A simple directional antenna is constructed from a linear array of small radiating antenna elements, and the same signal with the same amplitude and the same phase is provided from one transmitting end to each antenna element. As the entire width of the array increases, the central beam becomes narrow; as the number of antenna elements increases, side robes become small.

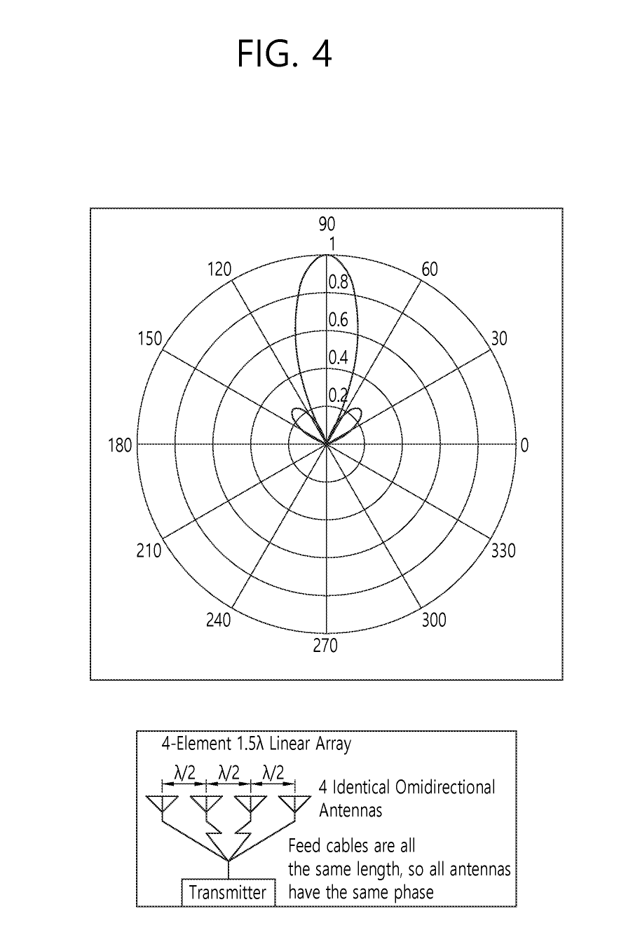

FIG. 4 illustrates a radiation pattern of a linear array antenna. FIG. 4 shows a radiation pattern of four small antenna elements disposed at an interval of 1λ/2.

Meanwhile, the radiation pattern of the linear array may be represented as a radiation pattern of a single antenna multiplied by an array factor (AF) representing impact of constructive interference and destructive interference of each antenna signal. That is, the array factor represents a change in maximum antenna gain according to a beam width.

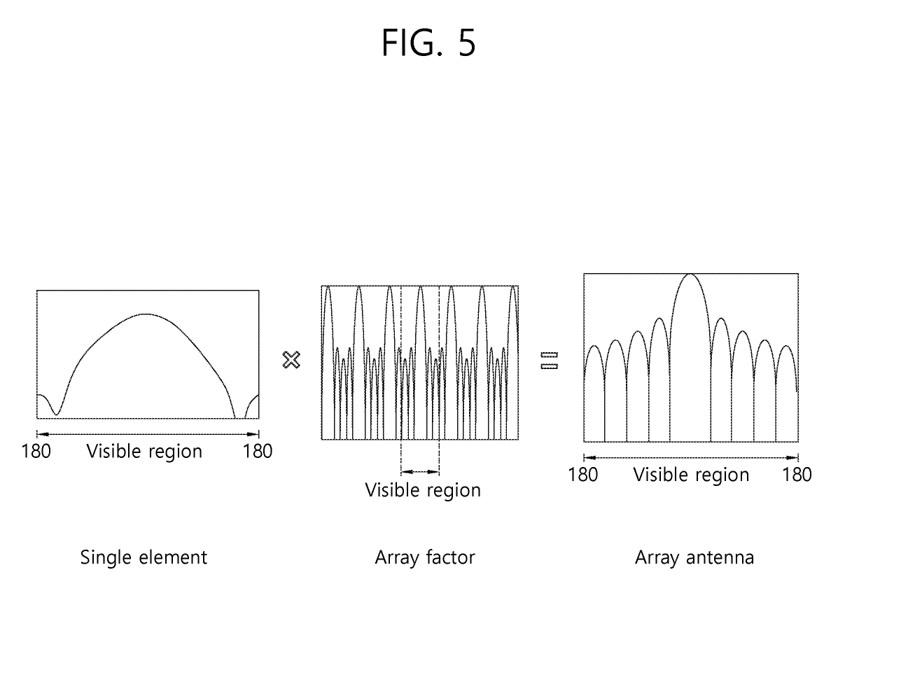

FIG. 5 illustrates a process of obtaining a radiation pattern of a linear array antenna. As shown in FIG. 5, an antenna gain may be obtained by multiplying a radiation pattern of a single antenna (single element) by an array factor.

An array factor may be changed based on the number of antennas forming an antenna array, the distance between antennas, and a weight by which each antenna is multiplied. The array factor may be represented as Equation 3.

$$AF ( θ ) = {\sum }_{n = 1}^{{N}_{r}} {w}_{n} {e}^{j ( n - 1 ) ( kd cos θ + φ )} \qquad [ Equation 3 ]$$

In Equation 3, N_{T} denotes the number of antennas, wₙ denotes a weight for each antenna, d denotes the distance between antennas, k=2π/λ denotes a wave number, θ denotes an angle from a directing point of an antenna array, and φ denotes a phase offset.

That is, when the heading direction (θ) of a beam from an antenna array is 0 and antennas are disposed at equal intervals, array factor values are expressed to be laterally symmetrical based on the heading direction.

In the case that a base station transmits a signal in a direction rotated through x degrees based on a boresight to which the antenna heads, an antenna gain at a directing point of a beam may be represented as Eᵣ(x)AF(0). Further, a beam gain at a point rotated through y degrees based on the directing point of the beam may be represented as Eᵣ(x+y)AF(y)

As shown in FIG. 5, a window (vision region) of an AF may be shifted according to θ applied to the AF, and a final antenna gain is obtained by multiplying the window and a corresponding antenna radiation pattern.

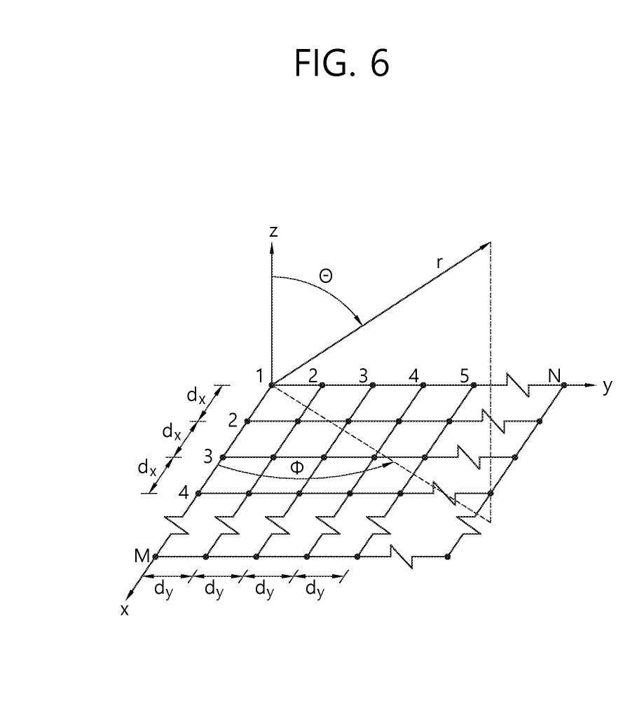

FIG. 6 is a diagram illustrating an array of antennas arranged in two-dimension.

As shown in FIG. 6, antennas may be arranged in a predetermined interval in a horizontal direction and a vertical direction. Herein, θ represents an azimuth angle and φ represents a vertical angle. Herein, dx and dy represent intervals between antenna devices in horizontal and vertical directions, respectively.

In the case that antennas are arranged as shown in FIG. 6,

AF(θ,φ)=AF_{H}(θ,φ)AF_{V}(θ,φ) [Equation 4]

In Equation 4, AF_{H} and AF_{V} may be represented as Equation 5 and Equation 6, respectively.

$$\begin{matrix}{AF}_{H} ( θ , φ ) = {\sum }_{n = 1}^{N} {w}_{1 n} {e}^{j ( n - 1 ) ( {kd}_{y} sin θ sin ϕ + {β}_{y} )} & [ Equation 5 ] \\ {AF}_{V} ( θ , φ ) = {\sum }_{m - 1}^{M} {w}_{m 1} {e}^{j ( m - 1 ) ( {kd}_{x} sin θ cos φ + {β}_{x} )} & [ Equation 6 ]\end{matrix}$$

Similarly, the radiation pattern of a single antenna may be represented by Eᵣ(θ,φ) as a variable of θ and φ.

Meanwhile, the partial frequency reuse technique described above is to mitigate the inter-cell interference by varying the size of a transmission power depending on the resource. According to the technique, since the maximum power is limited for the resource allocate to the interior cell, a signal may not be transmitted with the maximum power of a radio frequency (RF) amplifier for the user equipment in the interior cell.

That is, when the partial frequency reuse technique is used, the performance deterioration may occur for the user equipments located in the interior cell in comparison with the network in which the partial frequency reuse technique is not used. Accordingly, the present invention proposes a method that may mitigate the inter-cell interference while minimizing the performance deterioration of the user equipments located in the interior cell.

As described above, in the huge MIMO system, the flexible beamforming technique in which the position, velocity, etc. of a moving user equipment may be utilized. In the present invention, even for the user equipment that is moving in the same velocity, a wide beam is transmitted to the cell interior resource for the user equipment located in the interior cell.

In the case that antennas are arranged in one-dimension, in order to remove or mitigate the inter-cell interference, the method of adjusting a beam width may be mainly used. However, in the case that antennas are arranged in two-dimension as shown in FIG. 6, in order to remove or mitigate the inter-cell interference, it should be considered the change of interference size in the cell-edge area according to the direction that a beam is directing vertically as well as the beam width. Accordingly, the present invention proposes a method for removing inter-cell interference that may be applicable to 2D antenna array by extending the 1D antenna array, and a method for signaling between base stations for the method.

The present invention proposes a method for removing inter-cell interference in the case of performing the flexible beamforming when a massive MIMO is constructed as 2D array. In the 2D antenna array, since the beamforming in a vertical surface as well as the existing beamforming in a horizontal surface are performed, the interference signal size of a cell-edge area should be anticipated by calculating the beam gain of the horizontal beamforming and the vertical beamforming.

In addition, in the case of the vertical beamforming, since the beam size that influences on the cell-edge area is changed depending on the directionality of a beam, the height of a base station and the coverage of a cell, these factors should be considered.

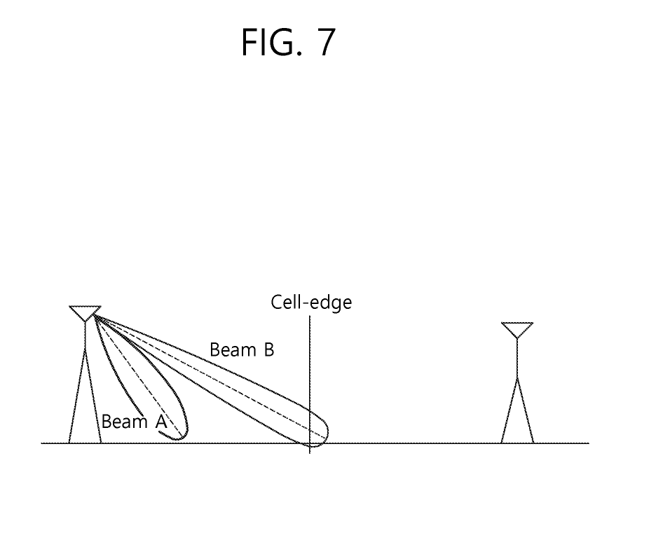

FIG. 7 is a diagram illustrating a change of beam gain depending on a directional point of a beam in the case of performing the vertical beamforming.

As shown in FIG. 7, the directional point of beam A is directing the inside of a cell, not a cell-edge, and the directional point of beam B is toward a boundary with a neighboring cell. It may be assumed that the beam gains of beam A and beam B are the same. As such, even in the case that the beam gains are the same, the amount of interference that exerts on the cell-edge area is changed depending on the angle of the point directed by the beam. Therefore, the inter-cell interference removal should be performed by considering the vertical directional point of the beam.

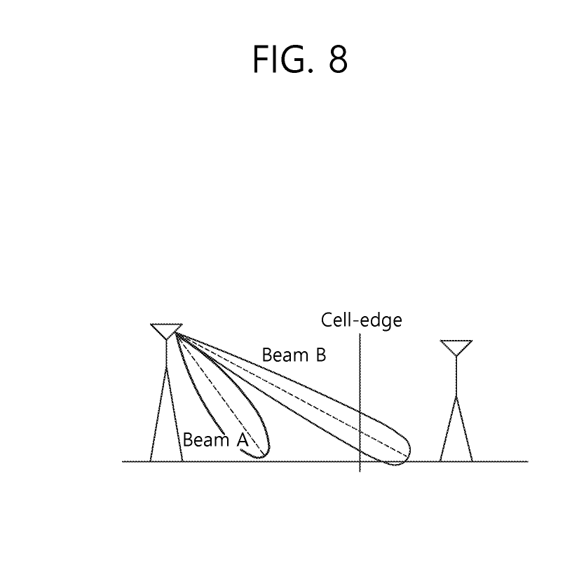

FIG. 8 is a diagram illustrating a case that the coverage of a cell is changed owing to the change of interval between base stations. Particularly, FIG. 8 shows the case that the interval between base stations is changed and the coverage of a cell becomes smaller.

The distance between base station B and base station A, shown in FIG. 8, is smaller than the distance between base station B and base station A shown in FIG. 7, and accordingly, the distance between the cell-edge and base station B shown in FIG. 8 is also smaller than that shown in FIG. 7.

When FIG. 7 and FIG. 8 are compared, even in the case of the beam that has the same antenna gain and the same vertical directional point, it may be anticipated that the signal size may be changed in the cell-edge area when the distance between base stations is changed.

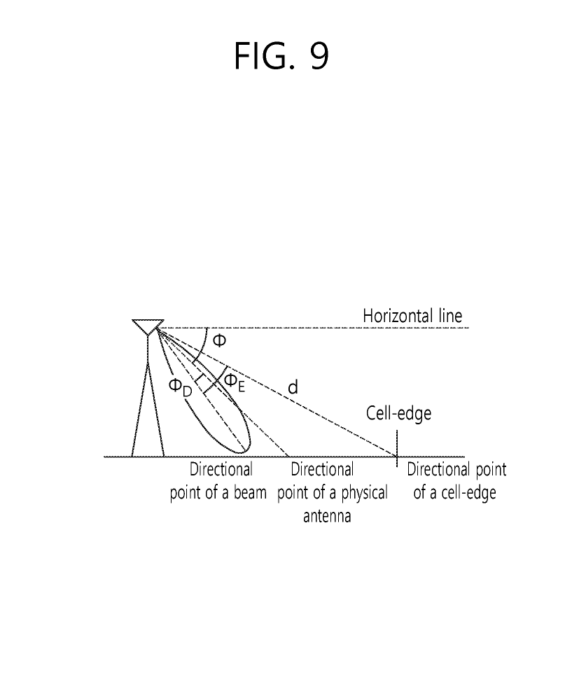

FIG. 9 is a diagram illustrating parameters for a vertical direction of a beam when two-dimensional beamforming is performed.

As illustrated, the directional point of a physical antenna and the directional point of a cell-edge may work as a variable of the parameters for a vertical direction owing to the tilt in the directional point of a beam and the antenna. The directional point of a physical antenna means the direction of the antenna which is physically tilted actually. In addition, by considering the directional point of a cell-edge as a variable of the parameters for a vertical direction, the antenna gain in the cell-edge direction may be considered.

In FIG. 9, Φ represents an angle between the directional point of the physical antenna and a horizontal line, Φ_{D} represents an angle between the directional point of the physical antenna and the directional point of the beam actually radiated, and Φ_{E} represents an angle difference between the directional point of the beam and the direction of the cell-edge area.

In addition, h represents a height of an antenna installed, and d represents a distance between the antenna and the cell-edge.

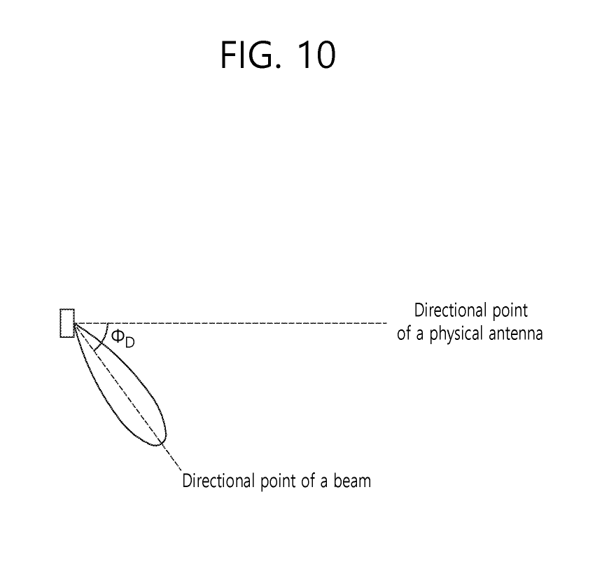

FIG. 10 is a diagram illustrating parameters for a horizontal direction of a beam when two-dimensional beamforming is performed. FIG. 10 shows the beam when the beam of FIG. 9 is seen in the sky, and θ_{D} represents an angle between the directional point of the physical antenna and the horizontal radiation direction of the beam.

In the case that the 2D antenna array is tilted downwardly from a horizontal line as much as Φ, the array factor (AF) at (θ_{D}, Φ_{D}), which the directional point of the beam, may also be obtained by substituting AF(0, 0) to Equation 7.

In addition, the AF in the cell-edge area may be expressed as AF(Φ_{E}, π) when Φ_{D} is 0 or more (Φ_{D}≧0), and may be expressed as AF(Φ_{E}, 0) when Φ_{D} is less than 0 (Φ_{D}<0). When u(Φ_{D}) is defined as Equation 7 below, the AF may be expressed as the simple form as represented in Equation 8.

$$\begin{matrix}u ( {φ}_{D} ) = \{ \begin{matrix}1 , & if {φ}_{D} \geq 0 \\ 0 , & if {φ}_{D} < 0\end{matrix} & [ Equation 7 ] \\ AF ( {φ}_{E} , π u ( {φ}_{D} ) ) & [ Equation 8 ]\end{matrix}$$

In Equation 7, the case that Φ_{D} is 0 or more may mean the directing point of a beam is directing to a ground surface rather than an actual antenna is directing to it, and the case that Φ_{D} is less than 0 may mean the directing point of a beam is directing over a ground rather than an actual antenna is directing to it.

Hereinafter, using Equation 8, a method for generating an RNTP signal will be described. In addition, according to the present invention, it may be assumed that a base station that performs beamforming may know Φ_{D} that represents the angle difference between the directing point of a beam and the direction of cell-edge area.

Φ_{E} may be changed depending on the distance between base stations, and since actual base stations are not installed with the same interval, when the distance from a neighboring base station is changed, the RNTP signal should be newly generated.

For example, in the case that base station B and base station C are existed beside base station A, and the distance between base station A and base station B is different from the distance between base station A and base station C, base station A should use different Φ_{D}s when calculating the RNTP which is forwarded to base station B and base station C, respectively.

In the case that base station 0 and base stations 1 to L adjacent to base station 0 are existed, a method for generating the RNTP signal (RNTP_{I}(n_{PRB})) that base station 0 transmits to base station 1(1≦1≦L) may be implemented as the following embodiments.

According to an embodiment, the restriction information of an RNTP may be determined by using the antenna gain of the direction directing a cell-edge.

Since the change of a vertical directing point of a beam causes the change of a signal size that influences on a cell-edge area, an RNTP value may be obtained using the value for the vertical directing point of a beam. The embodiment therefor may be expressed by Equation 9.

$$RNTP ( {n}_{PRB} ) = \{ \begin{matrix}0 & if & {AF}_{max} ( {n}_{PRB} ) \leq {RNTP}_{threshold} \\ 1 & if & {AF}_{max} ( {n}_{PRB} ) > {RNTP}_{threshold}\end{matrix} \qquad [ Equation 9 ]$$

In Equation 9, AFₘₐₓ(n_{PRB}) means the maximum value among AF(0) values of a UE-specific physical downlink shared channel (PDSCH) RE that may be scheduled during a future time interval. RNTP_{threshold} may be expressed by RNTP_{threshold}ε{−∞, a₁, a₂, . . . a_{L}}.

The case that RNTP_{threshold} is −∞ may mean that the inter-cell interference control is not performed using the RNTP. a_{L} may be determined by considering an inter site distance, an antenna configuration, a traffic load distribution, and the like.

According to Equation 9, the RNTP value becomes 0 when AFₘₐₓ(n_{PRB}) is equal to or smaller than a specific RNTP_{threshold}, and becomes 1 when AFₘₐₓ(n_{PRB}) is greater than a specific RNTP_{threshold}.

Meanwhile, an antenna gain may be obtained by the multiplication of the AF and the radiation pattern of a single antenna. According to another embodiment of the present invention, in order to generate the antenna gain more precisely, the RNTP is determined by using the value of the AF multiplied by the radiation pattern of a single antenna.

The radiation pattern of an antenna inclined in (θ_{D}, Φ_{D}) direction may be obtained based on Equation 6. (θ_{D}, Φ_{D}) may be replaced by the expression of (θ, Φ).

In the case that the 2D antenna array is inclined below from a horizontal line as much as Φ, (θ_{D}, Φ_{D}), which is the directional point of a beam may be transformed to be substituted by FIG. 6 and Equation 4, and these may be expressed as sin θ_{D}=sin θ sin Φ and sin Φ_{D}=sin θ cos Φ, respectively. That is, these may be expressed by Φ=tan⁻¹(sin θ_{D}/sin Φ_{D}) and θ=arcsin(sin θ_{D}/sin(tan⁻¹(sin θ_{D}/sin φ_{D}))).

When the transformed Φ and θ are put to Eᵣ(θ,φ), the radiation pattern for a single antenna may be expressed as below.

$$\begin{matrix}{E}_{r} ( θ , φ ) = {E}_{r} ( arcsin ( \frac{sin {θ}_{D}}{sin ( {tan}^{- 1} ( \frac{sin {θ}_{D}}{sin {φ}_{D}} ) )} ) , {tan}^{- 1} ( \frac{sin {θ}_{D}}{sin {φ}_{D}} ) \\ = {E}_{r}^{′} ( {θ}_{D} , {φ}_{D} )\end{matrix} \qquad [ Equation 10 ]$$

When the RNTP is expressed by reflecting Equation 10, it is reduced to Equation 11.

$$RNTP ( {n}_{PRB} ) = \{ \begin{matrix}0 & if & {wAG}_{max} ( {n}_{PRB} ) \leq {RNTP}_{threshold} \\ 1 & if & {wAG}_{max} ( {n}_{PRB} ) > {RNTP}_{threshold}\end{matrix} \qquad [ Equation 11 ]$$

In Equation 11, wAGₘₐₓ(n_{PRB}) means the maximum value among AG×HPBW values of a UE-specific physical downlink shared channel (PDSCH) RE that may be scheduled during a future time interval.

RNTP_{threshold} may be expressed by RNTP_{threshold}ε{−∞, a₁, a₂, . . . a_{L}}. The case that RNTP_{threshold} is −∞ may mean that the inter-cell interference control is not performed using the RNTP.

According to another embodiment of the present invention, in order to overcome the decrease of reception power, a signal may be transmitted by amplifying the power of a beam of wide width. In this case, the RNTP value may be determined by using both of an antenna gain and an EPRE. That is, according to an example of the present invention, an RNTP restriction information may be determined by using the maximum value in which an antenna array radiation pattern, a single antenna gain and an EPRE are multiplied.

In the case that an RNTP is obtained by multiplying the EPRE of a user equipment to AF(φ_{E},πu(φ_{D}))Eᵣ(θ_{D},φ_{E}−φ_{D}u(φ_{D})) of Equation 11, when a signal is transmitted using more energy even in the case of the same antenna gain, the amount of interference that influences on a neighboring cell may be more increased.

In order to accurately measure the amount of interference that influences on a neighboring cell, the equation for determining an RNTP by multiplying an EPRE to an antenna gain is as follows.

$$RNTP ( {n}_{PRB} ) = \{ \begin{matrix}0 & if \frac{{E}_{AG} ( {n}_{PRB} )}{{E}_{max\_nom}^{( p )}} \leq {RNTP}_{threshold} \\ 1 & if no promise about the upper limit of \frac{{E}_{AG} ( {n}_{PRB} )}{{E}_{max nom}^{( p )}} is made\end{matrix} \qquad [ Equation 12 ]$$

In Equation 12, E_{AG}(n_{PRB}) means the maximum value among AG×EPRE values of a UE-specific physical downlink shared channel (PDSCH) RE that may be scheduled during a future time interval.

RNTP_{threshold} may be expressed by RNTP_{threshold}ε{−∞, a₁, a₂, . . . a_{L}}. The case that RNTP_{threshold} is −∞ may mean that the inter-cell interference control is not performed using the RNTP.

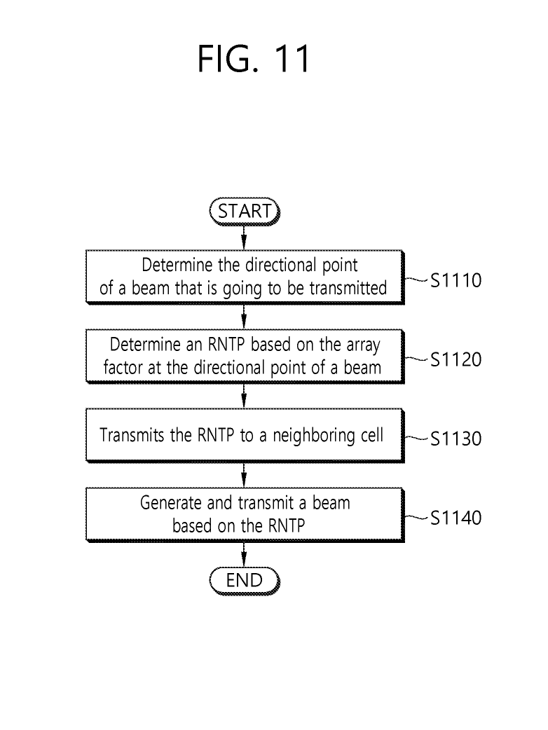

FIG. 11 is a diagram for describing a signal transmission method according to an embodiment of the present invention.

Referring to FIG. 11, an RNTP determination method and a signal transmission method according to it are described as follows.

First, a signal transmission device such as a base station that may transmit a signal to a user equipment determines the beam width of a beam that is going to be transmitted (step, S1110).

In the case that antenna are arranged in two-dimension, the directional point of a beam may be expressed as Equation 10 by considering a directional point of a physical antenna and the directional point for a cell-edge, which is a degree of inclination of an actual antenna.

The base station may determine an RNTP based on the array factor at the directional point of a beam (step, S1120).

The RNTP information that is expressed as an RNTP indicator or an RNTP value may represent whether the transmission power for a specific resource block of a cell is maintained below a specific upper limit, and therefore, may represent whether the base station transmits a signal in a cell-edge.

The base station may calculate the array factor as represented in Equation 11 by considering the directional point of a beam, and by using the array factor calculated as such, the RNTP information may be determined.

The base station may determine the RNTP to be either one of 0 or 1 by comparing the calculated array factor with the preconfigured array factor.

Otherwise, the base station may determine the RNTP information using the array gain for a beam. The array gain may be derived by multiplying a single antenna gain for transmitting a beam by the array factor, and the base station may determine the RNTP to be either one of 0 or 1 by comparing the calculated array gain with the preconfigured array gain.

According to another embodiment, the base station may calculate the gain energy that is induced by the multiplication of the array gain for the beam by the maximum energy for a resource block, and may also determine the RNTP using the gain energy calculated as such.

The base station may determine the RNTP to be either one of 0 or 1 by comparing the gain energy with the preconfigured gain energy.

In this case, in order to more accurately measure an amount of interference of a neighboring cell of the radiated signal, the base station may attribute weighting to a beam width when the AG is calculated.

As such, when the RNTP is determined by the various conditions and calculations, the base station transmits the determined RNTP to a neighboring cell (step, S1130).

Since the case that the RNTP is 1 may represent that a transmission power is maintained in a specific resource block, that is, a signal is transmitted, the neighboring cell that receives it may not allocate a signal to the specific resource block. On the contrary, since the case that the RNTP is 0 may represent that a signal is not transmitted to the corresponding resource block, the neighboring cell that receives it may allocate a signal to the specific resource block.

The base station may generate a beam based on the determined RNTP. When the RNTP is generated, the base station may transmit it (step, S1140).

As such, the base station may determining whether to perform beamforming based on the RNTP, and by notifying it to a neighboring cell, may increase the utilization of the partial frequency reuse technique and mitigate the inter-cell interference. The RNTP for determining beamforming may be determined by the beam width for securing the mobility of a user equipment existed in the interior of a cell and the directional point of a beam, and the array factor and/or the antenna gain, and the like may be used for the factor for determining the RNTP.

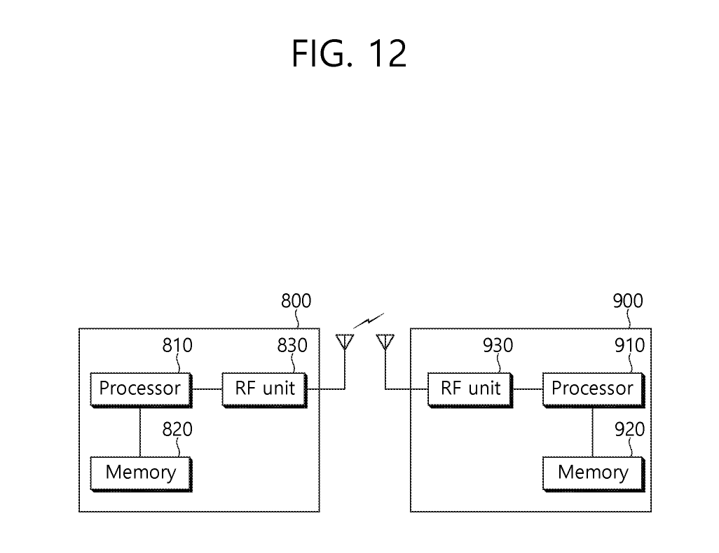

FIG. 12 is a block diagram of a wireless communication system according to an embodiment of the present invention.

The base station 800 includes a processor 810, a memory 820, and an RF (radio frequency) unit 830. The processor 810 implements functions, processes, and/or methods as suggested herein. The layers of a wireless interface protocol may be implemented by the processor 810. The memory 820 is connected with the processor 810 and stores various pieces of information for driving the processor 810. The RF unit 830 is connected with the processor 810 and transmits and/or receives radio signals.

The user equipment 900 includes a processor 910, a memory 920, and an RF unit 930. The processor 910 implements functions, processes, and/or methods as suggested herein. The layers of a wireless interface protocol may be implemented by the processor 910. The memory 920 is connected with the processor 910 and stores various pieces of information for driving the processor 910. The RF unit 930 is connected with the processor 910 and transmits and/or receives radio signals.

The processor may include an application-specific integrated circuit (ASIC), a separate chipset, a logic circuit, and/or a data processing unit. The memory may include a read-only memory (ROM), a random access memory (RAM), a flash memory, a memory card, storage medium, and/or other equivalent storage devices. The RF unit may include a base-band circuit for processing a radio signal. When the embodiment of the present invention is implemented in software, the aforementioned methods can be implemented with a module (i.e., process, function, etc.) for performing the aforementioned functions. The module may be stored in the memory and may be performed by the processor. The memory may be located inside or outside the processor, and may be coupled to the processor by using various well-known means.

As described above, the present invention proposes a method for configuring a relative narrowband transmit power (RNTP) value for performing an inter-cell interference control in a communication system in which the flexible beamforming is applied.

In the above-described systems, the methods are described with the flowcharts having a series of steps or blocks, but the present invention is not limited to the steps or order. Some steps may be performed simultaneously or in a different order from other steps. It will be understood by one of ordinary skill that the steps in the flowcharts do not exclude each other, and other steps may be included in the flowcharts or some of the steps in the flowcharts may be deleted without affecting the scope of the invention.

The embodiments described above may include various aspects of examples. Although it is not possible to describe all available combinations for representing various aspects, those ordinary skilled in the art may understand that other various combinations are available. Accordingly, it is understood that the present invention includes all of other alternations, modifications and changes that are belonged to the claims below.

What is claimed is:

1. A method for transmitting a signal, comprising:
determining a directional point of a beam that is going to be transmitted;
determining relative narrowband transmit power (RNTP) information that represents whether a transmission power greater than a preconfigured threshold value is transmitted to a preconfigured resource block based on the directional point of a beam; and
transmitting the RNTP information to a neighboring cell, and transmitting a generated beam to the resource block according to the RNTP information.

2. The method of claim 1, further comprising calculating an array factor that includes the directional point of a beam and information of a change of a maximum antenna gain in a cell-edge direction according to the directional point of a beam,
wherein determining the RNTP information is determined by comparing the array factor with a preconfigured array factor.

3. The method of claim 1, further comprising calculating an array gain for the beam,
wherein determining the RNTP information is determined by comparing the array gain with a preconfigured array gain.

4. The method of claim 3, wherein calculating the array gain for the beam performs a multiplication of a single antenna gain for transmitting a beam by an array factor that includes information of the directional point of a beam and a change of a maximum antenna gain in a cell-edge direction according to the directional point of a beam.

5. The method of claim 1, further comprising calculating an array gain for the beam and a gain energy induced by a multiplication of the array gain for the beam by a maximum energy for a resource block,
wherein determining the RNTP information is determined by comparing the gain energy with a preconfigured gain energy.

6. The method of claim 5, wherein calculating the gain energy includes calculating the array gain by performing a multiplication of a single antenna gain for transmitting a beam by an array factor that includes information of the directional point of a beam and a change of a maximum antenna gain in a cell-edge direction according to the directional point of a beam.

7. A signal transmitting device, comprising:
a signal transceiver; and
a processor connected with the signal transceiver,
wherein the processor is configured to perform:
determining a beam width that is going to be transmitted, determining relative narrowband transmit power (RNTP) information that represents whether a transmission power greater than a preconfigured threshold value is transmitted to a preconfigured resource block based on the beam width, and transmitting the RNTP information to a neighboring cell, and transmitting a generated beam to the resource block according to the RNTP information.
